(19) United States
(12) Patent Application Publication
(10) Pub. No.: US 2024/0184986 A1
(43) Pub. Date: Jun. 6, 2024

(54) Text Suggestion Based on Environmental Context

(71) Applicant: Apple Inc., Cupertino, CA (US)

(72) Inventors: Christopher D. Fu, Fremont, CA (US); Devin W. Chalmers, Oakland, CA (US); Paulo R. Jansen dos Reis, San Jose, CA (US)

(21) Appl. No.: 18/286,608

(22) PCT Filed: Apr. 26, 2022
(86) PCT No.: PCT/US22/26322

§ 371 Date: Oct. 12, 2023

Related U.S. Application Data
(60) Provisional application No. 63/182,076, filed on Apr. 30, 2021.

(51) Int. Cl. G06F 40/274; G06F 3/04886; G06V 20/50; G06V 20/70; G10L 25/51

(52) U.S. Cl. CPC G06F 40/274; G06F 3/04886; G06V 20/50; G06V 20/70; G10L 25/51

(57) ABSTRACT

In one implementation, a method of displaying text suggestions is performed at a device including an input device, a display, an image sensor, one or more processors, and non-transitory memory. The method includes obtaining, using the image sensor, one or more images of a physical environment. The method includes obtaining one or more semantic labels associated with the physical environment based on the one or more images of the physical environment. The method includes receiving, via the input device, text. The method includes determining one or more text suggestions based on the one or more semantic labels associated with the physical environment and the text. The method includes displaying, on the display, the one or more text suggestions.

### CROSS-REFERENCE TO RELATED APPLICATIONS

This application claims priority to U.S. Provisional Patent App. No. 63/182,076, filed on Apr. 30, 2021, which is hereby incorporated by reference in its entirety.

### TECHNICAL FIELD

The present disclosure generally relates to systems, methods, and devices for generating text suggestions based on environmental context.

### BACKGROUND

In various applications, a user entering text is provided with suggestions for completing the text. However, in various implementations, such suggestions are unrelated the text the user wishes to enter.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIGS. 4A-4E illustrate an XR environment during various time periods in accordance with some implementations.

FIG. 5 is a flowchart representation of a method of displaying content in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying text suggestions based on environmental context. In various implementations, the method is performed by a device including an input device, a display, an image sensor, one or more processors, and non-transitory memory. The method includes obtaining, using the image sensor, one or more images of a physical environment. The method includes obtaining one or more semantic labels associated with the physical environment based on the one or more images of the physical environment. The method includes receiving, via the input device, text. The method includes determining one or more text suggestions based on the one or more semantic labels associated with the physical environment and the text. The method includes displaying, on the display, the one or more text suggestions.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

In various applications, while a user is entering text, a device displays suggestions for completing the text. For example, while a user is entering a search query in a search engine, suggestions are displayed based on the text already entered. As another example, while composing a message to another user, suggestions are displayed based on the text already entered. However, in various implementations, these suggestions do not incorporate context from the environment in which the user is entering the text. Accordingly, in various implementations disclosed herein context from the environment is which the user is entering text is used to generate text suggestions for additional text.

For example, if the environment includes a table and the user has input “TA” into a search engine, it is more likely that the user would be interested in search results related to “TABLEWARE” or “TABLECLOTH” than “TACO SEASONING” or “TAPESTRY”. As another example, if a song by an artist named “ARTISTNAME” is playing in the environment and the user has input “ART” into a search engine, it is more likely that the user would be interested in search results related to “ARTISTNAME” than “ART GALLERIES NEAR ME”.

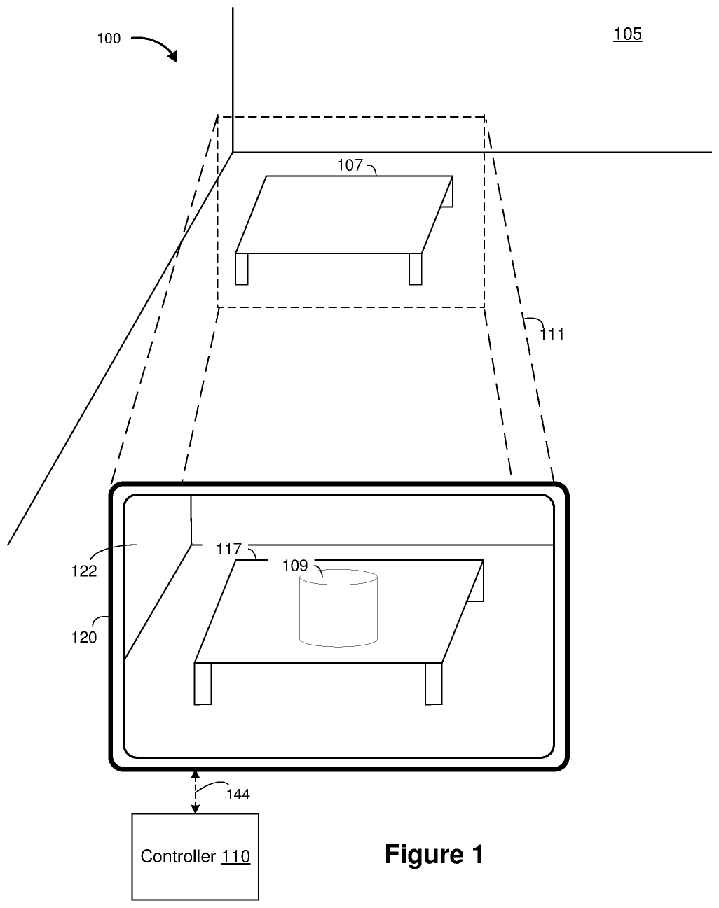

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

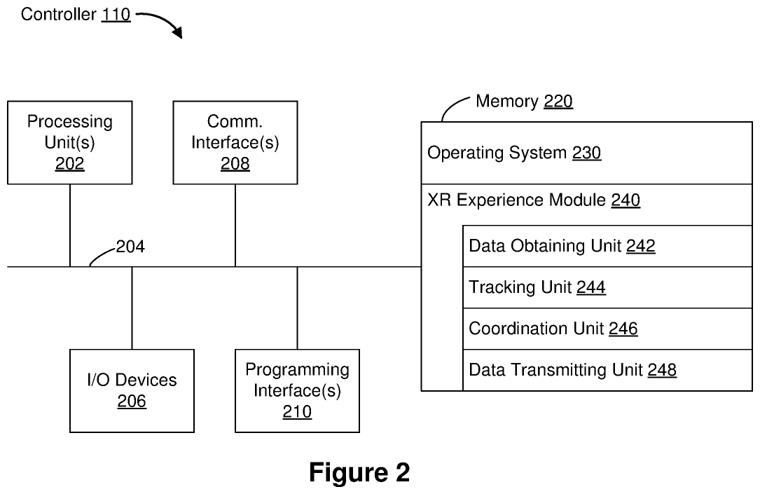

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

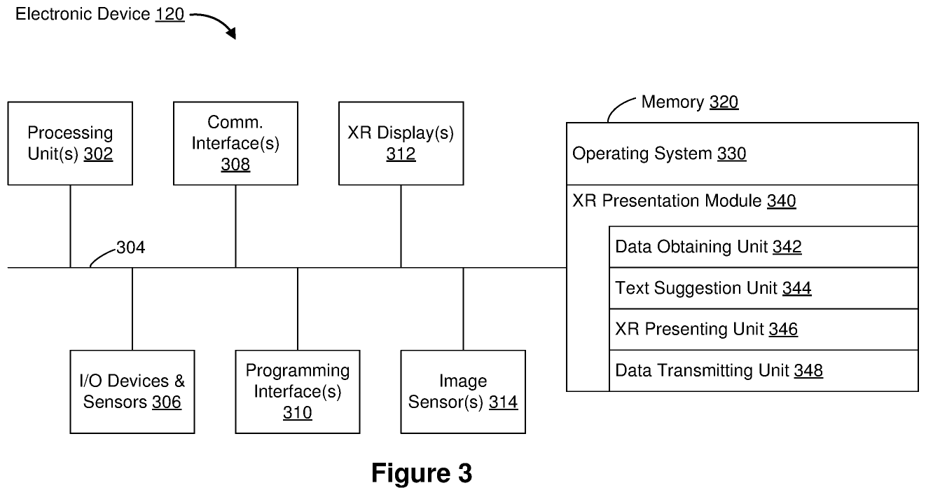

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the scene as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, a text suggestion unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. To that end, in various implementations, the data obtaining unit 342 includes instructions and/or logic therefor, and heuristics and metadata therefor.

In some implementations, the text suggestion unit 344 is configured to generate text suggestions based on previously entered text and context of the physical environment in which the text was previously entered. To that end, in various implementations, the text suggestion unit 344 includes instructions and/or logic therefor, and heuristics and metadata therefor.

In some implementations, the XR presenting unit 346 is configured to present XR content via the one or more XR displays 312, such as a representation of the selected text input field at a location proximate to the text input device. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. In some implementations, the data transmitting unit 348 is configured to transmit authentication credentials to the electronic device. To that end, in various implementations, the data transmitting unit 348 includes instructions and/or logic therefor, and heuristics and metadata therefor.

Although the data obtaining unit 342, the text suggestion unit 344, the XR presenting unit 346, and the data transmitting unit 348 are shown as residing on a single device (e.g., the electronic device 120), it should be understood that in other implementations, any combination of the data obtaining unit 342, the text suggestion unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

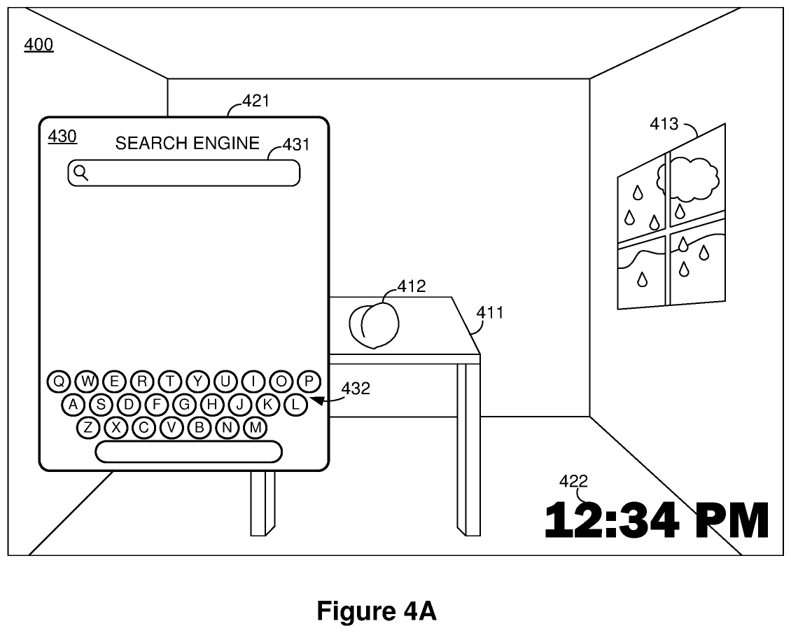

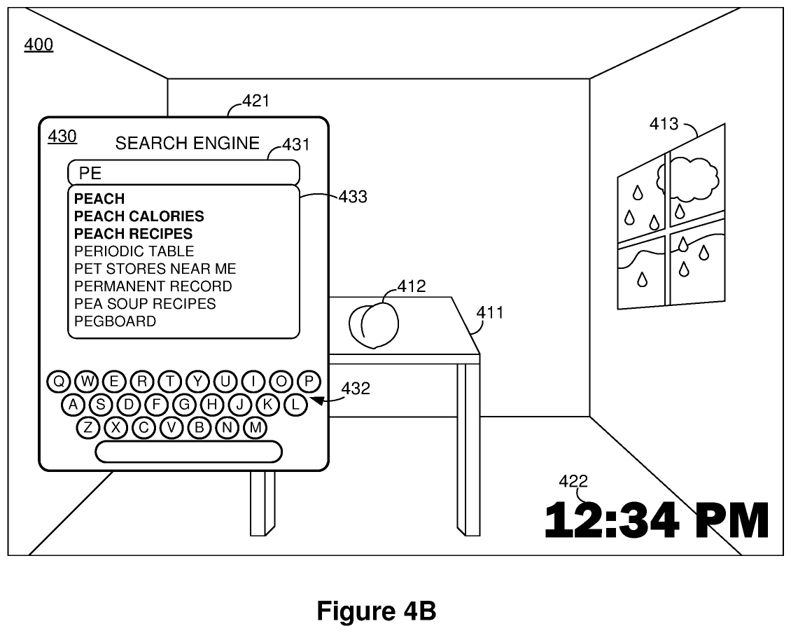

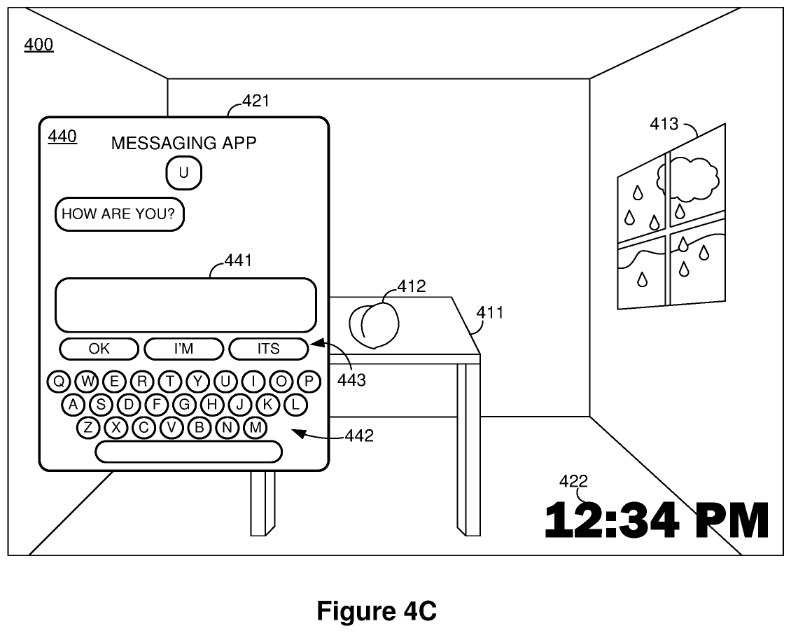

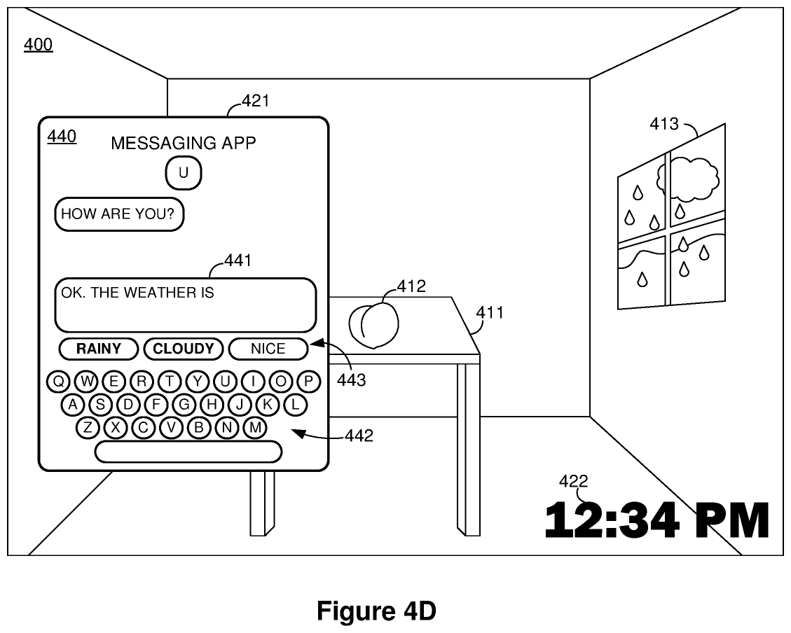

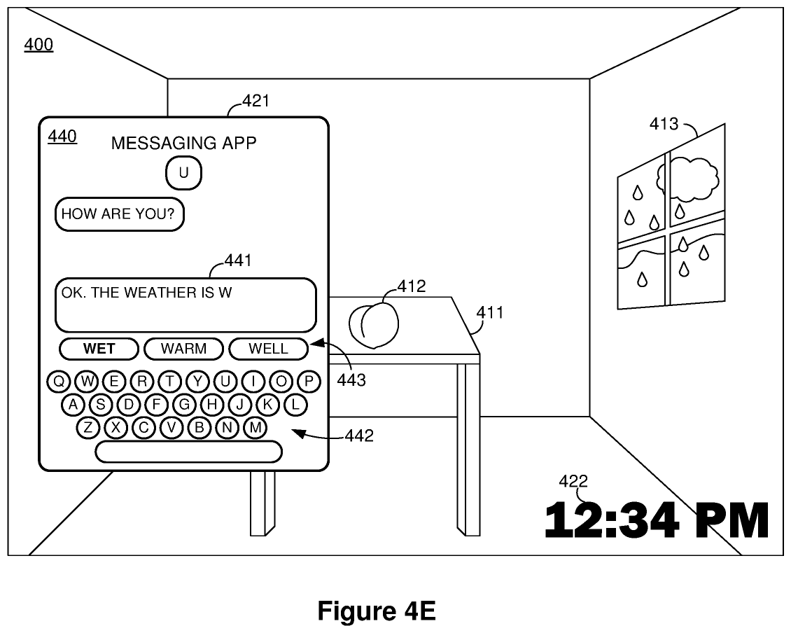

FIGS. 4A-4E illustrate an XR environment 400 displayed, at least in part, by a display of the electronic device. The XR environment 400 is based on a physical environment of a kitchen in which the electronic device is present. FIGS. 4A-4E illustrate the XR environment 400 during a series of time periods. In various implementations, each time period is an instant, a fraction of a second, a few seconds, a few hours, a few days, or any length of time.

The XR environment 400 includes a plurality of objects, including one or more physical objects (e.g., a table 411, a peach 412, and a window 413) of the physical environment and one or more virtual objects (e.g., a user interface pane 421 and a virtual clock 422). In various implementations, certain objects (such as the physical objects 411-413 and the user interface pane 421) are displayed at a location in the XR environment 400, e.g., at a location defined by three coordinates in a three-dimensional (3D) XR coordinate system. Accordingly, when the electronic device moves in the XR environment 400 (e.g., changes either position and/or orientation), the objects are moved on the display of the electronic device, but retain their location in the XR environment 400. Such virtual objects that, in response to motion of the electronic device, move on the display, but retain their position in the XR environment are referred to as world-locked objects. In various implementations, certain virtual objects (such as the virtual clock 422) are displayed at locations on the display such that when the electronic device moves in the XR environment 400, the objects are stationary on the display on the electronic device. Such virtual objects that, in response to motion of the electronic device, retain their location on the display are referred to as head-locked objects or display-locked objects.

FIG. 4A illustrates the XR environment 400 during a first time period. During the first time period, the user interface pane 421 includes a search engine user interface 430. The search engine user interface 430 includes a search bar 431 and a keyboard 432. By interacting with the keys of the keyboard 432, text is input into the search bar 431.

FIG. 4B illustrates the XR environment 400 during a second time period subsequent to the first time period. Between the first time period and the second time period, a user has interacted with the keyboard 432 to input “PE” into the search bar 431. Based on this user input, the search engine user interface 430 includes a plurality of search suggestions 433. The search suggestions are based on both the text input into the search bar 431, e.g., “PE” and context of the XR environment 400, e.g., that the peach 412 is present in the XR environment 400. In various implementations, the search suggestions are based on other information, such as user search history, aggregate search history (e.g., of other users), time, location, and other such information which may be used to facilitate search recommendations. In various implementations, search suggestions that are based on the context of the XR environment 400 are displayed differently than search suggestions that are based only on the text input into the search bar 431 and, optionally, other information. For example, in FIG. 4B, the search suggestions “PEACH”, “PEACH CALORIES”, and “PEACH RECIPES” are displayed in bold. In various implementations, search suggestions that are based on the context of the XR environment 400 are displayed in a different color, a different size, or at a different location than other search suggestions.

In various implementations, by selecting a particular search suggestion, the text input into the search bar is replaced with the text of the particular search suggestion and search results based on a search query of the text of the particular search suggestion are displayed.

FIG. 4C illustrates the XR environment 400 during a third time period. During the third time period, the user interface pane 421 includes a messaging user interface 440. The messaging user interface 440 includes a message composition area 441 and a keyboard 442. By interacting with the keys of the keyboard 442, text is input into the message composition area 441.

In various implementations, by selecting a particular text suggestion, the text of the particular text suggestion is input into the message composition area 441.

FIG. 4D illustrates the XR environment 400 during a fourth time period subsequent to the third time period. Between the third time period and the fourth time period, a user has interacted with the keyboard 442 to input text into the message composition area 441. Based on this user input, the messaging user interface 440 includes a plurality of text suggestions 443 proximate to the keyboard 442. The text suggestions are based on both the text input into the message composition area 441, e.g., mentioning “WEATHER” and context of the XR environment 400, e.g., that it is raining outside the window 413 in the XR environment 400. In various implementations, the text suggestions are based on other information, such as historical user text input, time, location, and other such information which may be used to facilitate text recommendations. In various implementations, search suggestions that are based on the context of the XR environment 400 are displayed differently than search suggestions that are based only on the text input into the search bar and, optionally, other information. For example, in FIG. 4D, the text suggestions “RAINY” and “CLOUDY” are displayed in bold. In various implementations, text suggestions that are based on the context of the XR environment 400 are displayed in a different color, a different size, or at a different location than other text suggestions.

FIG. 4E illustrates the XR environment 400 during a fifth time period subsequent to the fourth time period. Between the fourth time period and the fifth time period, the user has interacted with the keyboard 442 to further input the letter “W” into the message composition area 441. Based on this user input, the text suggestions 443 are changed to reflect that the desired word begins with the letter “W”. In particular, “WET” has been prioritized over “WARM” and “WELL” based at least in part on a determination that it is raining outside the window 413 in the XR environment 400.

In various implementations, by selecting a particular text suggestion, the final partial word of the text input in the message composition area 441 is replaced with the text of the particular text suggestion. In various implementations, a complete word is followed by a space or punctuation mark, whereas a partial word is not followed by a space or punctuation mark.

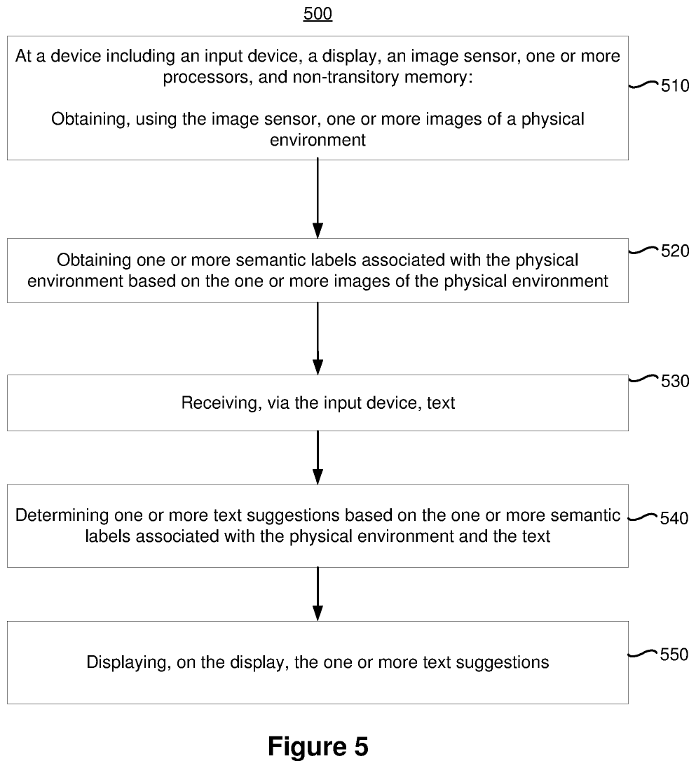

FIG. 5 is a flowchart representation of a method 500 of displaying content in accordance with some implementations. In various implementations, the method 500 is performed by a device including an input device, a display, an image sensor, one or more processors, and non-transitory memory (e.g., the electronic device 120 of FIG. 3). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device obtaining, using the image sensor, one or more images of a physical environment. The method 500, continues, in block 520, with the device obtaining one or more semantic labels associated with a physical environment based on the one or more images of the physical environment. In various implementations, each semantic label is a word or phrase.

In various implementations, obtaining the one or more semantic labels associated with the physical environment includes detecting an object in the one or more images of the physical environment and obtaining one or more semantic labels associated with the object. For example, in FIGS. 4A-4E, in response to detecting the peach 412 in an image of the physical environment upon which the XR environment 400 is based, the electronic device determines a semantic label of “peach”. In various implementations, the electronic device further determines semantic labels of “fruit”, “juicy”, “Georgia”, and “nectarine”. As another example, in FIGS. 4A-4E, in response to detecting rain outside the window 413 in an image of the physical environment upon which the XR environment 400 is based, the electronic device determines a semantic label of “rain”. In various implementations, the electronic device further determines semantic labels of “rainy”, “cloudy”, “wet”, “storm”, and “cold”.

In various implementations, the method 500 comprises obtaining audio, e.g., using a microphone, of the physical environment and obtaining the one or more semantic labels associated with the physical environment is further (or alternatively) based on the audio of the physical environment. In various implementations, obtaining the one or more semantic labels associated with the physical environment includes detecting an event in the audio of the physical environment and obtaining one or more semantic labels associated with the event. For example, in various implementations, the device detects a song titled “SONGNAME” by “ARTISTNAME” in the audio of the environment and determines semantic labels of “SONGNAME” and “ARTISTNAME”. In various implementations, the device detects frogs croaking and determines semantic labels of “frog”, “croak”, “ribbit”, and “nature”. In various implementations, the device detects an alarm and determines semantic labels of “alarm”, “fire”, and “emergency”.

In various implementations, obtaining the one or more semantic labels is further (or alternatively) based on data from at least one of a thermometer, barometer, hygrometer, light sensor, or physical locator (e.g., a GPS sensor). For example, in various implementations, the device detects weather conditions and obtains semantic labels related to those conditions. For example, in various implementations, in response to detecting a high temperature, the device obtains a semantic label of “hot”. In various implementations, in response to detecting dark conditions, the device obtains a semantic label of “dark”. In various implementations, in response to determining that the device is in Los Angeles, the device obtains semantic labels of “Los Angeles” and “California”. In various implementations, the device obtains a semantic label of a venue at which the device is located, such as “grocery store” or “Grocermart”.

Accordingly, in various implementations, the device further comprises an additional sensor (in addition to the image sensor) and the method 500 includes obtaining, from the additional sensor, environmental information of the physical environment and obtaining the one or more semantic labels is based on the environmental information. For example, in various implementations, the additional sensor includes a microphone and the environmental information includes audio of the physical environment. Thus, in various implementations, obtaining the one or more semantic labels associated with the physical environment includes detecting an event in the audio of the physical environment and obtaining one or more semantic labels associated with the event. In various implementations, the additional sensor includes at least one of a thermometer, barometer, hygrometer, light sensor, or physical locator.

The method 500 continues, in block 530, with the device receiving, via the input device, text. In various implementations, the text includes one or more alphanumeric characters. In various implementations, the input device is a physical keyboard. In various implementations, the input device is a touch-sensitive display, e.g., detecting user interaction with a displayed keyboard. In various implementations, the input device is a camera, e.g., detecting user interaction with a virtual keyboard using extremity tracking. Thus, in various implementations, a camera operates as a sensor to obtain one or more semantic labels associated with the physical environment and as an input device to receive text. In various implementations, the text includes multiple words. For example, in FIG. 4D, the message composition area 441 includes multiple words. In various implementations, the text includes a partial word. For example, in FIG. 4B, the search bar 431 includes the partial word “PE”.

The method 500 continues, in block 540, with the device determining one or more text suggestions based on the one or more semantic labels associated with the physical environment and the text. In various implementations, each text suggestion includes one or more alphanumeric characters. In various implementations, a particular text suggestion includes a single word or multiple words. For example, in FIG. 4B, the text suggestions 433 include the single word “PEACH” and the multiple-word phrase “PEACH CALORIES”.

The method 500 continues, in block 550, with the device displaying, on the display, the one or more text suggestions. For example, in FIG. 4B, the electronic device displays the search suggestions 433 proximate to the search bar 431. Thus, in various implementations, the one or more text suggestions are displayed proximate to the text. As another example, in FIG. 4D, the electronic device displays the text suggestions 443 proximate to the keyboard 442. Thus, in various implementations, the one or more text suggestions are displayed proximate to a keyboard used to receive the text.

In various implementations, the method 500 further includes receiving, via the input device, selection of a particular text suggestion of the one or more text suggestions and performing a search with the particular text suggestion as a search query. For example, in FIG. 4B, in response to selection of one of the search suggestions 433, the electronic device performs a web search based on the selected text suggestion.

In various implementations, the text is entered into a text field, and the method 500 further includes receiving, via the input device, selection of a particular text suggestion of the one or more text suggestions and entering the particular text suggestion in the text field. For example, in FIG. 4D, in response to selection of one of the text suggestions 443, the electronic device enters the selected text suggestion into the message composition area 441.

In various implementations, the method 500 further includes determining a respective one or more weights for the one or more semantic labels associated with the physical environment and determining the one or more text suggestions (in block 530) is further based on the respective one or more weights. For example, in FIGS. 4A-4E, in response to detecting the peach 412 in an image of the physical environment upon which the XR environment 400 is based, the electronic device determines a semantic label of “peach” with a weight of 0.8. In various implementations, the electronic device further determines semantic labels of “fruit” with a weight of 0.4, “juicy” with a weight of 0.2, “Georgia” with a weight of 0.1, and “nectarine” with a weight of 0.05. When a finite number of text suggestions are determined, those related to semantic labels with a higher weight are more likely to be determined.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1-20. (canceled)

21. A method comprising:
at a device including an input device, an image sensor, a display, one or more processors, and non-transitory memory:
obtaining, using the image sensor, one or more images of a physical environment;
obtaining one or more semantic labels associated with the physical environment based on the one or more images of the physical environment;
receiving, via the input device, text;
determining one or more text suggestions based on the one or more semantic labels associated with the physical environment and the text; and
displaying, on the display, the one or more text suggestions.

22. The method of claim 21, wherein obtaining the one or more semantic labels associated with the physical environment includes detecting an object in the one or more images of the physical environment and obtaining one or more semantic labels associated with the object.

23. The method of claim 21, further comprising obtaining audio of the physical environment, wherein obtaining the one or more semantic labels associated with the physical environment is further based on the audio of the physical environment.

24. The method of claim 23, wherein obtaining the one or more semantic labels associated with the physical environment includes detecting an event in the audio of the physical environment and obtaining one or more semantic labels associated with the event.

25. The method of claim 21, wherein the obtaining the one or more semantic labels is further based on data from at least one of a thermometer, barometer, hygrometer, light sensor, or physical locator.

26. The method of claim 21, wherein the device further comprises an additional sensor, further comprising obtaining, from the additional sensor, environmental information of the physical environment, wherein obtaining the one or more semantic labels is based on the environmental information.

27. The method of claim 26, wherein the additional sensor includes a microphone and the environmental information includes audio of the physical environment.

28. The method of claim 27, wherein obtaining the one or more semantic labels associated with the physical environment includes detecting an event in the audio of the physical environment and obtaining one or more semantic labels associated with the event.

29. The method of claim 26, wherein the additional sensor includes at least one of a thermometer, barometer, hygrometer, light sensor, or physical locator.

30. The method of claim 21, further comprising determining a respective one or more weights for the one or more semantic labels associated with the physical environment, wherein determining the text suggestion is further based on the respective one or more weights.

31. The method of claim 21, wherein the text is entered into a text field, further comprising receiving, via the input device, selection of a particular text suggestion of the one or more text suggestions and entering the particular text suggestion in the text field.

32. The method of claim 21, further comprising receiving, via the input device, selection of a particular text suggestion of the one or more text suggestions and performing a search with the particular text suggestion as a search query.

33. The method of claim 21, wherein the text includes a partial word.

34. The method of claim 21, wherein the text includes multiple words.

35. The method of claim 21, wherein the one or more text suggestions are displayed proximate to the text.

36. The method of claim 21, wherein the one or more text suggestions are displayed proximate to a keyboard used to receive the text.

37. A device comprising:
an input device;
a display;
an image sensor;
a non-transitory memory; and
one or more processors to:
obtain, using the image sensor, one or more images of a physical environment;
obtain one or more semantic labels associated with the physical environment based on the one or more images of the physical environment;
receive, via the input device, text;
determine one or more text suggestions based on the one or more semantic labels associated with the physical environment and the text; and
display, on the display, the one or more text suggestions.

38. The device of claim 37, wherein the one or more processors are to obtain the one or more semantic labels associated with the physical environment by detecting an object in the one or more images of the physical environment and obtaining one or more semantic labels associated with the object.

39. The device of claim 37, further comprising an additional sensor, wherein the one or more processors are further to obtain, from the additional sensor, environmental information of the physical environment and to obtain the one or more semantic labels based on the environmental information.

40. A non-transitory memory storing one or more programs, which, when executed by one or more processors of a device including an input device, a display, and an image sensor, cause the device to:
obtain, using the image sensor, one or more images of a physical environment;
obtain one or more semantic labels associated with the physical environment based on the one or more images of the physical environment;
receive, via the input device, text;
determine one or more text suggestions based on the one or more semantic labels associated with the physical environment and the text; and
display, on the display, the one or more text suggestions.
